(19) United States
(12) Patent Application Publication
(10) Pub. No.: US 2024/0289903 A1
(43) Pub. Date: Aug. 29, 2024

(54) Evaluation and Comparison System

(71) Applicant: Amit Batra, London (GB)

(72) Inventor: Amit Batra, London (GB)

(21) Appl. No.: 18/692,802

(22) PCT Filed: Sep. 16, 2022
(86) PCT No.: PCT/GB2022/052363

§ 371 Date: Mar. 16, 2024

(30) Foreign Application Priority Data
Sep. 16, 2021 (GB) 2113243.6

(51) Int. Cl. G06Q 50/16

(52) U.S. Cl. CPC G06Q 50/16

(57) ABSTRACT

A system for evaluating a particular subject of a class, comprising a feature list comprising a plurality of features corresponding to a characteristics or qualities of the subject to be evaluated, the ordering of the features on the feature list being determined by a user, the order of features on the feature list being associated with a weighting or ranking position value for that feature, each feature having a score field in which the user enters a score associated with the feature, the system calculating a global score for the subject being calculated by multiplying the score associated with the feature with the weighting/ranking associated with the feature, over a selected number of features.

### CROSS-REFERENCES TO RELATED APPLICATIONS

This Non-Provisional National Stage Patent application claims the benefit of and priority to PCT Patent Application Serial No. PCT/GB2022/052363, filed Sep. 16, 2022, entitled “Evaluation and Comparison System,” which claims the benefit of and priority to the United Kingdom Patent Application Serial No. GB 2113243.6, filed Mar. 16, 2021, entitled “Evaluation and Comparison System,” the entire contents of both applications are hereby incorporated herein by reference.

### BACKGROUND

The present specification relates to evaluation, comparison and decision making systems, particularly but not exclusively for the sale and rental of residential property.

When a person is deciding to buy or rent a property, it can be difficult to evaluate which property is best suited, as there may be a very large choice of properties, a large variation in the characteristics or features of each property, and there are many different criteria which vary from person to person and from property to property. Each individual may consider one characteristic or feature as being more important to them than another characteristic or feature, particularly when considering an individual person's decision making process.

Furthermore, each property will have different characters or features to any other property in a person's property search.

Existing property search tools often allow someone to search within a geographic area, and further to let upper and lower limits on characteristics such as price and number of bedrooms, and to filter by property type or other characteristics, such as whether the property is detached or not. Even so, often a large number of results are returned, and the person has to spend a lot of time going through the results, and making an uncertain choice often based on a subjective evaluation. Even after a property viewing, a person may not have considered or included certain property features or characteristics before making a decision to place an offer for the rental or purchase of their subject property.

### SUMMARY

The object of the present invention is to provide a convenient system which allows a user to rank or score properties on a more objective manner. This will help the user make a more informed and percentage based decision or score.

According to the present invention, there is provided a system according to claim 1.

The system can be used to evaluate any subject within a class or related classes where different subjects have features or characteristics which vary within the class. For example, the subjects may be particular residential properties, and the classes being property types such as ‘houses’, ‘apartments’ or ‘for sale’ or ‘for rental’, however the system can equally be applied with necessary adaptations to evaluating different cars, or even personal relationships or many other fields. Where a decision is required and presented by way of a simple percentage score.

### BRIEF DESCRIPTION OF THE DRAWINGS

The invention will now be described, by way of example, with reference to the drawings, of which

FIG. 1 is a flow chart showing the steps of a property evaluation and comparison system;

FIG. 2 shows an input display for the system;

FIG. 3 shows an input display for a later stage of the system;

FIG. 4 shows a result display for the system;

FIG. 5 shows an input display for another embodiment of the system;

FIG. 6 shows a comparison of different some possible embodiments of the system;

FIG. 7 is a flow chart showing the steps another embodiment of the property evaluation and comparison system;

FIG. 8 is a flow chart showing the steps a further embodiment of the property evaluation and comparison system;

FIG. 9 is a display of the generated marketing material of the property evaluation and comparison system;

FIG. 10 shows a diagrammatic view of another embodiment of the input display of the system;

FIG. 11 shows a diagrammatic view of another embodiment of the input display of the system;

FIG. 12 shows a screenshot of another embodiment of the input display of the system;

FIG. 13 shows a screenshot of another embodiment of the input display of the system;

FIG. 14 shows a screenshot of an embodiment of the output display of the system; and

FIG. 15 shows a screenshot of a further embodiment of the output display of the system.

### DETAILED DESCRIPTION

The evaluation and comparison system is typically provided as an application running on a processing device having an input means and display, ideally the processing device is a mobile device such as a mobile phone, tablet computer, laptop or desktop computer.

The system will typically be installed on the mobile device, typically as a progressive web application though it could be operated e.g. in a browser over the internet with the display being updated as necessary. On starting the application, a pre-opening title introduction page and disclaimer could be displayed, to inform the user that the application is for informational use and not to be relied on for legal purposes, and a confirmation tick box may be provided for the user to indicate their consent.

### Basic Version (for Property Buyers and Tenants Only)

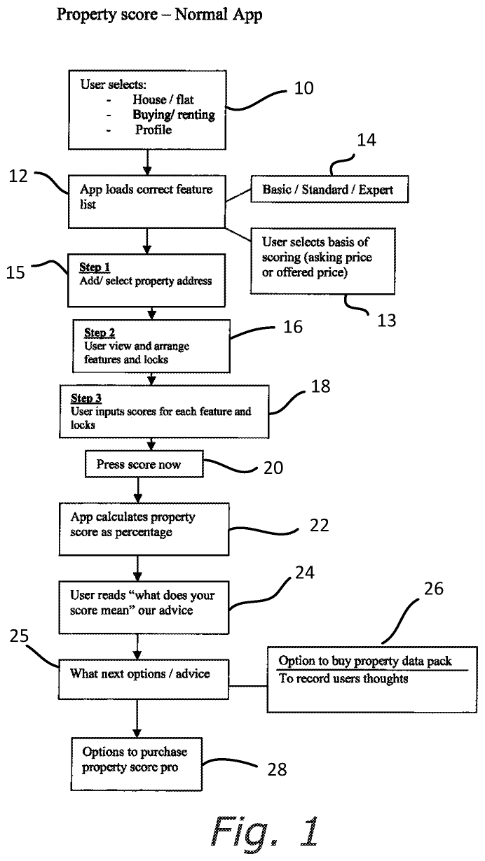

Referring to FIG. 1, as a first step, the user is prompted 10 to input particular criteria which will determine the form of the output, and in some cases the features list and algorithm used. For example, the user may be prompted to input their country and/or language, the type of property (such as apartment or house), whether they will be buying or renting, and the user profile (i.e. single person, small family, couple etc.). The inputs may be provided as drop-down menus for the user to select. There will also be a “basis of scoring” selection where the user is prompted to select from an asking price or an offered price in the scoring process 13. The selection of ‘asking price’ or ‘offered price’ does not itself affect the algorithm, but may affect how the user orders, and in particular scores, the features; furthermore the selection may be noted in any disclaimer as to whether or not the user may wish to rely on the score provided.

The system may provide more than one algorithm, and the user may also be prompted 14 to choose which version they wish to use; specifically, Basic, Standard or Expert versions as well as premium upgrades within each version; where the premium upgrade gives the user a larger number of features/characteristics to be taken into consideration as well as other options and benefits. There may also a version for letting and estate agents, some of which may be provided without cost, and some with additional features requiring payment 14.

The user is then prompted 15 to insert the address of a property, and optionally to insert additional information (If the user decides to do so) under various headings such as property photos, property floorplan, agents' brochure, property description, property bullet points, property video, a display of the property on a local map (scalable); using the properties post-code.

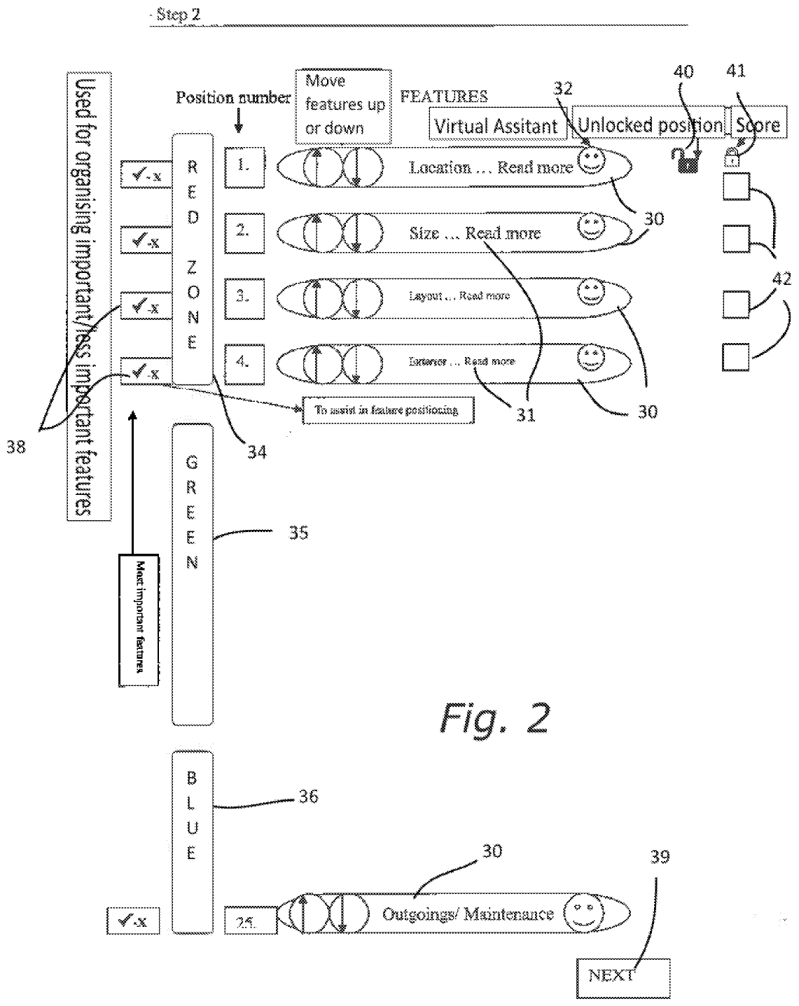

Referring also to FIG. 1 the user is presented 16 with a list of property features 30 (on FIG. 2) depending on whether the user has selected a house for sale/house for rental, or flat for sale/flat for rental in previous step 10. (FIG. 1) The feature lists that will be displayed, will correspond to the option selected by the user. Therefore, there are 4 possible feature lists.

The user can click on the individual feature titles 31 (FIG. 2) to understand what is meant by each title, so that a paragraph or two about what each property feature means will be displayed in a pop-up screen. A virtual assistant 32 built within the system or/and with the use of training videos, the user can be guided through the system as well as reading out the context of the property feature's description.

Examples of features, and their explanatory rubric, for the system is being used to evaluate a property for sale are as follows—
1) Central Location: Consider:
The property's location in relation to the centre of your nearest large town or city.
The overall time it would take you and the distance as well as the cost to get primarily to the centre of the nearest town/city.
If there is more than one town or city nearby?
What are the transport links connecting your property to the city or town centre like?
If there is a bus or train service? If so, what is their frequency?
if you can get to the centre of town by bicycle or by walking?
If you are travelling by car, consider parking your car in the centre.

2) Personal Locality: Consider:
Your property's location in relation to your personal circumstances; your distance to work; your partner's distance to work.
Your distance/journey times to schools.
Your distance to places that you would regularly visit. It could be friends, family or anywhere else that you would need to travel to, on a regular basis.
The time it would take you, the physical distance and even the cost. Are they manageable or excessive?
Your mode of transport as well as parking and your return journey.

3) Neighbourhood: Consider:
The safety, quietness and overall appeal of the neighbourhood surrounding your property
The type and style of neighbouring properties.
If your property is in an affluent neighbourhood?
The school catchment area and the facilities offered by the local authority.
The surrounding neighbourhoods to your neighbourhood. Are they prosperous, up and coming, or impoverished?
If there is any major building work or construction happening or planned in your neighbourhood. How will this impact you and for how long?

4) Size (Sq ft): Consider:
The overall size of the property. This is often indicated on a floor plan.
The size excluding wasted space, like the area of the stairway and areas with reduced ceiling height.
if this property is large enough for your immediate and future needs?
Is there any room size where you are having to compromise on?
The size of the property compared to the asking price? (Price per sq ft or price per sq m).

Does it represent good value?

5) Internal Layout: Consider:
The internal layout as shown on a floor plan.
If the layout of your property is usable, well laid out or has it got a lot of wasted space?
if you have to go through one room to get to another?
The widths of the rooms and hallway space. Are there any narrow or awkward areas?
If there is a central hallway leading to all of the rooms?
Would you need to change the layout?

It will be evident that a large number of potential features could be provided; further some features may be relevant only for buying a property, and some features relevant only for rental of a property, while many features may be relevant to both. The appropriate list of features provided is based on the user selection 10, and dependent upon what version of the system the user has selected or subscribed to.

The user can arrange the list of features 30 of a property in an order with the most important ones to them by clicking on arrows 34 provided for each feature 30, or by holding and dragging the feature to the desired position. The features order may be arranged so that the difference in rank or importance of the feature is displayed with the more important ones on the top of the list. These may be shown with a red bar or zone 34, (for example, the top three or four features, 30 here being shown), though this number can of course be varied. Features of lesser importance may be distinguished in a similar manner, here the next most important features (e.g. the next three or four features) being shown with a green bar 35, and the last four or five features of least importance being indicated with a blue bar 36. It will be realised that the relative importance of the features can be indicated in various largely equivalent ways, such as changing the colour of the background, the colour of the text, or indicating a colour gradient. Alternatively or additionally, the importance may be indicated by non-colour means, such as displaying a number or by showing e.g. a horizontal bar whose length is proportional to the importance. The number of features provided for ordering may be varied depending on the version provided, for example the Standard or Expert versions may include more possible feature titles and descriptions for ordering. The features included are relevant to the particular choice made by the user made in step 10, for example so that the features shown for Basic version may be different than those shown for Standard or Expert versions, though of course some features may be common to both. The features may be ordered or arranged in various alternative ways, for example by a ‘drag and drop’ method or by using the arrow keys 34 (FIG. 2).

To make the feature arrangement process easier for the user, a system of “ticks, crosses and minus signs” may be provided. If the user considers a feature as being important, the user is able to designate a “tick” next to it; on the left hand side 38 (FIG. 2). Similarly, if the user considers a feature to be of little importance, he or she is able to designate a “cross” next to it. Every remaining feature will then be designated a “minus sign”. The minus sign does not mean subtract, it simply means “of medium importance” to the user. However, the order and importance of the features may be set simply by the selection method previously described.

Now the user can group all the “ticked” features towards the top of the screen, (red zone 34); and move the “crossed” features to the bottom of the screen (blue zone 36); leaving the “minus” signed features in the middle. (Green zone 35). This would make it easier for the user to arrange the “ticked, minus signed and crossed” features into an arrangement of importance. In addition, online video instructions are provided showing the best way for the user to organise their feature list.

Once the user has ordered and arranged the features 30 to their satisfaction, the order arrangement may be locked for use in the next steps by the user pressing on a feature padlock symbol 40, which may change from depicting an unlocked padlock to a locked padlock to indicate the state. The user may proceed to the next step by pressing the “next” button 39 only after locking the feature arrangement. This is done simply by the user clicking on the padlock. Alternatively, pressing the next button could lock the feature order automatically. The feature order is now stored for use as the desired order by the user, for their chosen property ready to be scored, as will be described below.

After ordering and locking the features 30, a padlock 41 positioned under the “score” heading, moves from the locked position to the unlocked position. A column of score boxes 42 is provided, each feature having a corresponding score box. While the order of features is being configured by the user, the score padlock symbol 41 immediately above the column indicates that these boxes cannot be selected. Once the order of the features is locked, the score boxes are unlocked and scores may be entered 18 (FIG. 1) into score option boxes 42; the padlock symbol 41 changes to indicate an unlocked state simultaneously with the padlock symbol for the feature order changing into a locked state for the feature order.

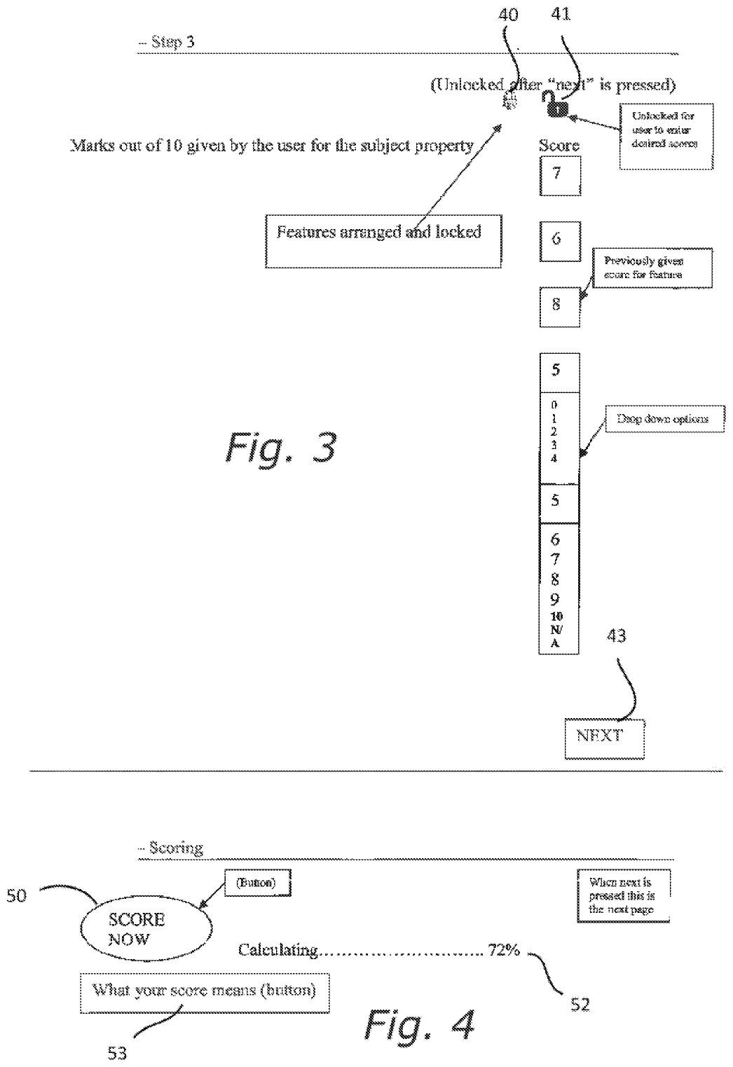

Also referring to FIGS. 3 and 2, each score option box 42 is provided with a dynamic drop-down box so that the user can enter a score for each feature 30, for example a simple score out of 10. E.g. 3 out of 10 or 8 out of 10. The user is free to enter any score out of 10 as the user sees fit for the feature or characteristic in their chosen property. The user can also give a score of zero out of ten if they wish.

A score may be given for each of the features independently. If a property does not have a specific feature, the user can use the N/A option for not applicable and ensure that the feature is moved to the bottom of the feature arrangement list 34. Alternatively or additionally, a zero score may be assigned to a features. The difference between a zero score and a N/A score is that the former is for a feature that is still being considered in the scoring process and therefore will have a bearing on your final score, whereas the latter will be completely omitted from the scoring process—that is, if a feature has a zero score then it is still contributes the maximum possible score still contributes to the total possible score to scale or normalise the other features' weight, whereas a score marked N/A is removed from the weighting process entirely.

Once the user has entered scores for each feature and wishes to proceed, they may move to the next stage of the process either by clicking the padlock symbol 41 to lock the values entered in the score boxes 42, or by pressing the “next” button 43 (shown in e.g FIG. 3) which could automatically lock the scores; the score padlock symbol 41 changes from an unlocked symbol to a locked symbol to indicate the scores have been locked.

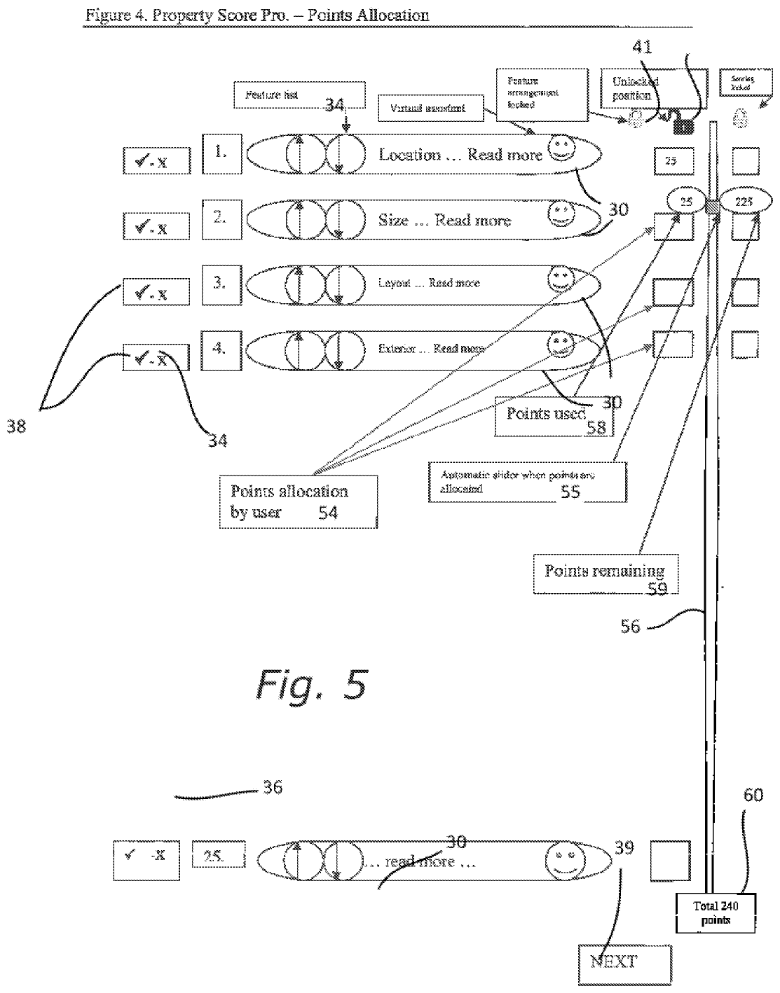

Referring to FIG. 4, once the score boxes have been locked, the user is presented with a display having a ‘score now’ button 50. Pressing 20 this button causes the system to execute 22 an algorithm to produce a score value. The algorithm ensures that more emphasis or mathematical importance is given to the upper-most features on the order list of features 30 (red zone) and gradually decreases in importance as the user's feature selection moves down into the green zone and the blue zone. The calculation performed by the algorithm produces a score relating to that property, which may conveniently be expressed as a percentage score. The final percentage scores take into account both the positioning of each feature as well as its score out of ten that the user has given to the feature.

### Examples of the Calculation Algorithm

If n features are provided, the most important feature may be assigned the number 1 and the further features numbered in order so that the least important feature is assigned the number n.

The sum of these numbers Sn=n/2×(n+1). A feature importance factor is then calculated by (n+1—assigned number)/Sn, to give a coefficient (or percentage by multiplying by 100) that can be used to weight each feature a uniform importance factor according to its importance.

The individual score for each feature is then multiplied by the weighted feature importance value; the sum of this product for all the features then gives an overall score for the property.

For example, if there are 25 features, the most important feature is assigned the number 1, and the least important feature the number 25, with the others arranged likewise in between. The sum of all the 25 numbers is 325. So the uniform importance factor given to the most important feature was 25/325=0.0769 or 7.69%, the second most important feature would be (24/325)×100%, i.e. 7.38% and so on, the least important feature would be (1/325)×100% i.e. 0.31% (rounding to 2 decimal places). Each of these importance factors is then multiplied by the score out of 10 given by the user, and results summed, to evaluate the total score for the property under consideration.

In the above example, the feature weighting is evenly distributed, so that for 25 features, the first-ranked feature has a weighting 25 times that of the 25th ranked feature. It will be realised however that the features may be weighted by other methods.

Once a percentage score has been achieved, the user may press 24 the “what does your score mean” button and guidance is given on what each percentage score means within percentage ranges.

For example, if a score is returned as in the 90% to 100% range, this indicates that the property closely satisfies the selected requirements of the user, and a recommendation to strongly consider renting or buying the subject property could be given. A score below 50% would indicate that the property does not fulfil the selected requirements of the user, and a recommendation that other properties should be considered can be given. Other percentage scores or percentage score ranges could give advice falling between these recommendations, proportional to the percentage score. Essentially this process can be applied to any modern day problem that requires a mathematical solution. This is ultimately a decision making tool.

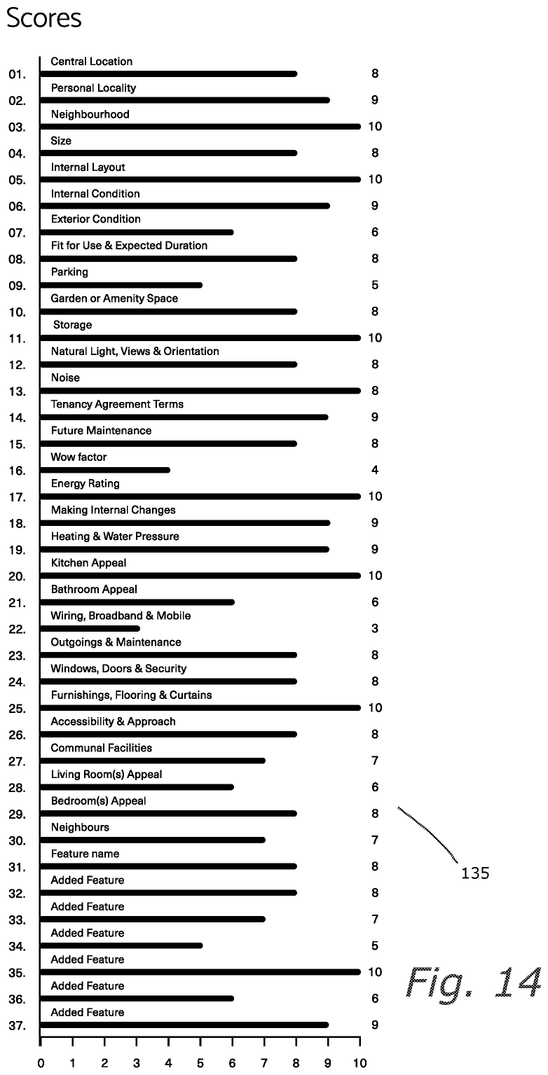

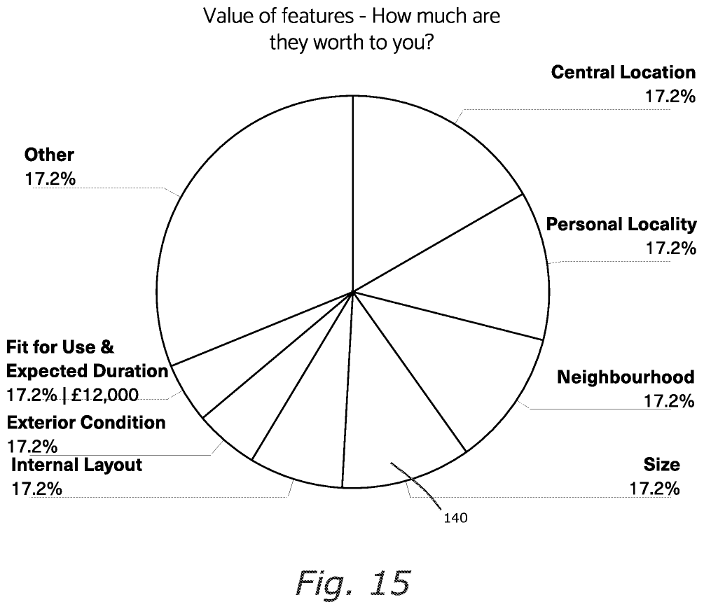

After the property has been evaluated by this method, the user may be presented with an option to subscribe 28 to a Standard or Expert version of the system if they have not already done so, and also offered an opportunity to by a buy 26 further services such as a property data pack for the property, and be prompted to enter their own notes on the property. Alternatively, the Standard or Expert versions may be selected initially by a user without having tried the Basic version. The property data pack could include basic details of the subject property, a summary of the percentage score, a histogram 135 as shown in FIG. 14 of the selected features and their user-given scores out of 10, a pie chart 140 of the selected features and their contributions and/or value as shown in FIG. 15, and other analyses of the selected features, their order, their scoring etc.

Options may also be provided to share the score or other data with friends, using a “share” option as is typical on any modern mobile device.

Further features and refinements can be offered in the Standard or Expert versions, or a subscription version provided to agents. Generally speaking, the feature list order is stored in the system (typically in a data file on the user's mobile device). The user may then evaluate a second and further properties by adding and selecting an option e.g., ‘evaluate or score new property’, which returns the user to the display of FIG. 1 and arranging new feature arrangements 31 (if desired to do so) and new scores in the score option boxes 42 for the features. Repeating the process described above will return a new percentage score for the second property, and the user then has an objective comparison between two or more properties, and can select the property with the highest score if the users decides to do so. The scores and details for each property can be stored on the system for the user to compare different properties at a later date. Alternatively if the score is high enough in the first property, the user can use the advice given and decide to make an offer to purchase or rent their subject property.

### Standard and Expert Versions—Method 1 Using Points

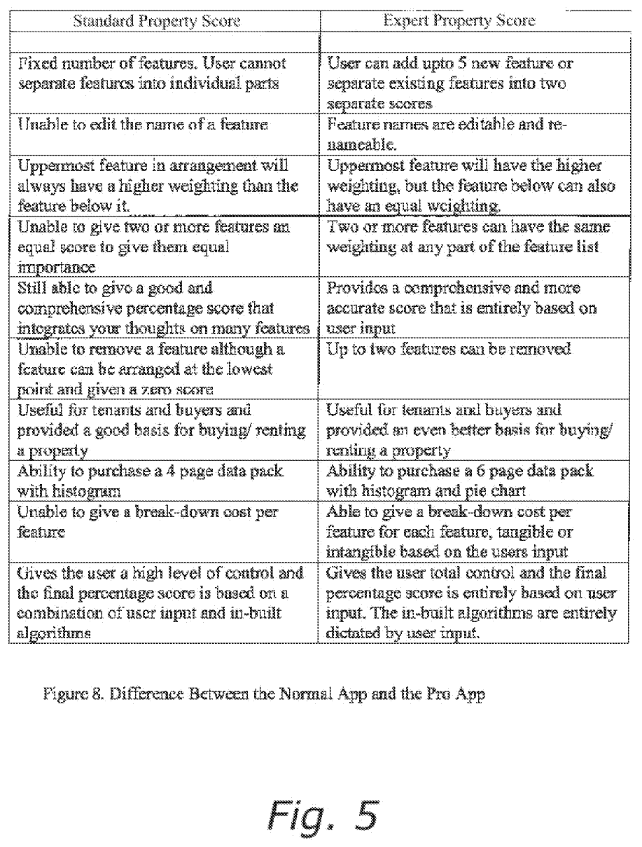

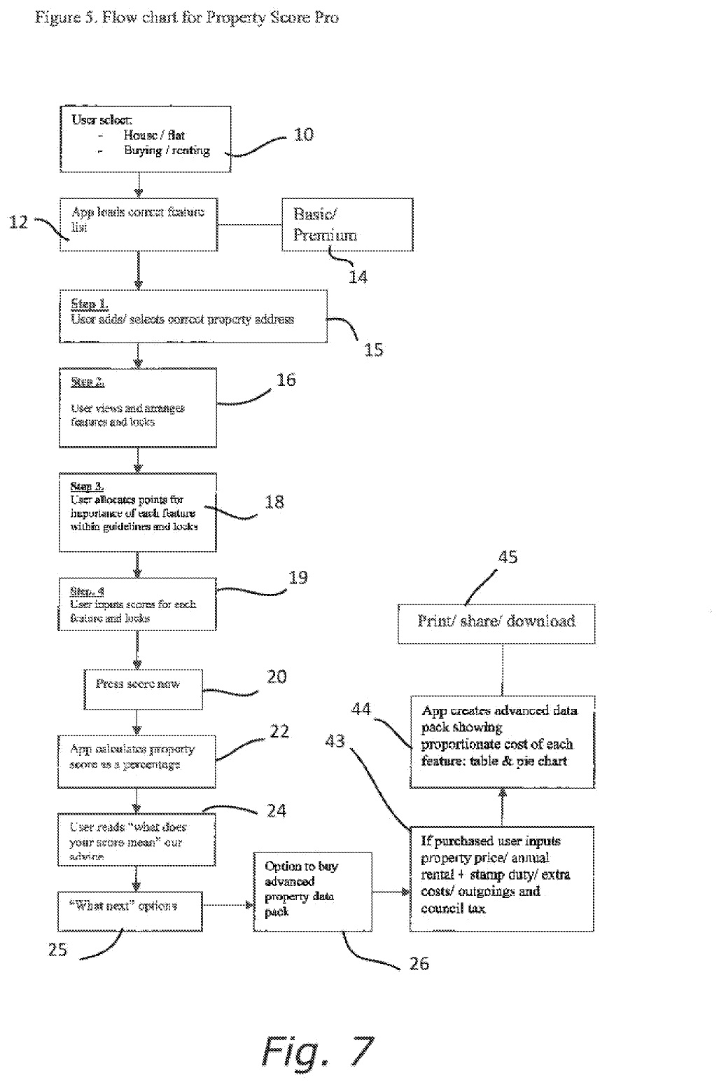

Referring to FIG. 5 and FIG. 7, a particular refinement provided for the system for professional users relates to the scoring 18 of the particular features previously ordered as described above. A sliding indicator icon 55 is provided on slider bar 56. Here, a number of points is provided for the scoring process, for example when the system is used for evaluating a house for purchase, there could be 240 total points allocated. The number of points provided can be varied for the particular function of the system (whether the property is a house or flat, or whether the user is buying or renting, and what subscription the user has).

When completing the scoring of a property, the user can allocate a number of points to each feature on his pre-arranged feature list 30. As points 54 are allocated for each feature, the slider 55 positioned on the right hand side of the display moves down to show how many points have been used and how many points are still available to be used, the position of the slider 55 being proportional to the number of points allocated/remaining. The number of points allocated and remaining can also be indicated by respective displays 58, 59 appearing either side of the slider 55, for example as a ‘hover over’ display function. The total number of points 60 can also be displayed, for example at the base of the slider bar 56.

The user can for example decide that the first feature is the most important and worth 25 points, the second feature may be worth 20 points and so on.

There are two rules that the user must obey, and the system will prevent inconsistent values being entered:

Rule 1. The user cannot allocate more points the second (or lower) feature that is lower than the feature above. For example if the first feature title is “location” and the user has given it 25 points then the second feature title which could be “size” can only be given 25 or less points but not more than 25 points. Similarly the third title may be “layout” and the user can allocate a less or equal amount of score than the one above (“size”).
Rule 2. The total number of points must add up to the number of points that were allocated depending on the users' choice of property. So, if in the above example the user has given 25 points to the “location” feature, the user now has 225 points remaining to be used in the other 24 features in the list. 61 (FIG. 5)

When all the points have been used, the user must lock the points.

Once the user has allocated the available points to each feature, and the total shows that all the allocated points have been used, in the above example, then the user can now mark each feature out of 10 as before in the previous version of the system. Once again the user must lock the points allocated and the scores at the end of their feature scoring process, and press the ‘score now’ button, as previously described in relation to FIGS. 3 and 2 above.

In this points based system, one algorithm to calculate a score out of 10 may be calculated thus

$${T}_{1} = \frac{1}{{n}_{p}^{*}} {\sum }_{1}^{n} ( user feature score from 0 to 10 )$$

$$Final percentage score = \frac{1}{10} {\sum }_{{T}_{1}}^{{T}_{n}} {T}_{n}$$

where n is the number of features not designated as N/A, Tn is the total number of feature points, Np is the total number of points, and n* is the adjusted number of features after N/A selections have been excluded.

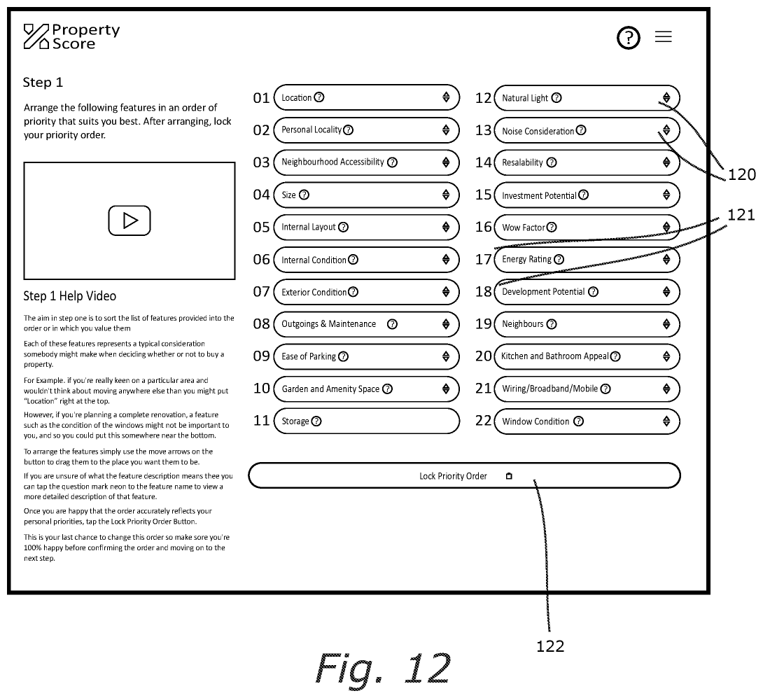

FIG. 12 shows a further embodiment of the system, where a simplified interface is provided which allows the user to order the features 120 by importance as indicated by an order number 121, and subsequently lock the order using a lock icon 122.

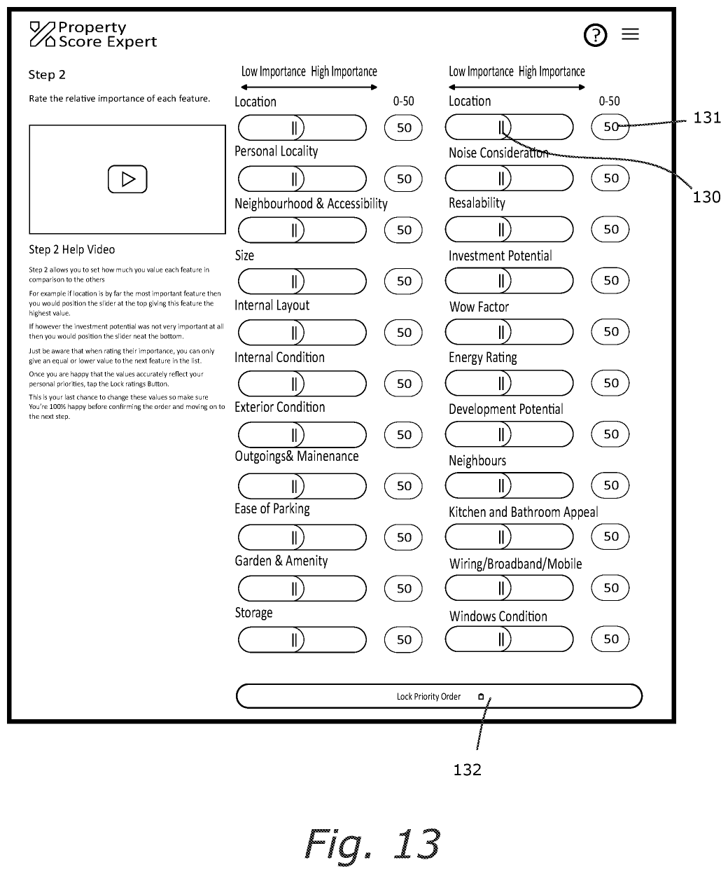

FIG. 13 shows a still further embodiment of the system, where an interface is provided which allows the user to allocate an importance of a features 130 by positioning a slider, with points 131 of the feature being automatically calculated by the system, and the order of the features 130 thence being automatically updated; again, once the order and points of the features are arranged to the user's satisfaction, they are subsequently locked using a lock icon 132.

As previously described under the ‘Examples of the calculation algorithm’ section, the system calculates a percentage score for the user of their subject property that uses:

1. The arrangement of features as prepared by the user.

2. The number of points allocated to each feature as awarded by the user.

3. The individual scores that have been input for each feature by the user.

The calculated percentage score can be compared to stored advisory information to indicate whether the buyer should purchase or not purchase (or rent or not to rent) the subject property as previously described when the user presses the “what your score means” button 53. As previously described, a “Property data pack” where the user can record the reason for giving a particular feature, a score, and where a display of the particular points allocation for all the feature grouping and scores, may be offered 26 to the user at this point, as shown in FIGS. 1, 7, 14 and 15.

In this version of the system, the user has the ability to give two or more features equal importance. This is not possible in the previously described embodiment, where the importance of each feature is determined by how they are ordered, with those positioned on the top given more importance than each feature positioned below it. But now, for example, internal condition, size and layout can all be given the same number of points giving them equal importance and having a bearing on the overall final percentage score obtained.

### Method 2—Use of Grouping

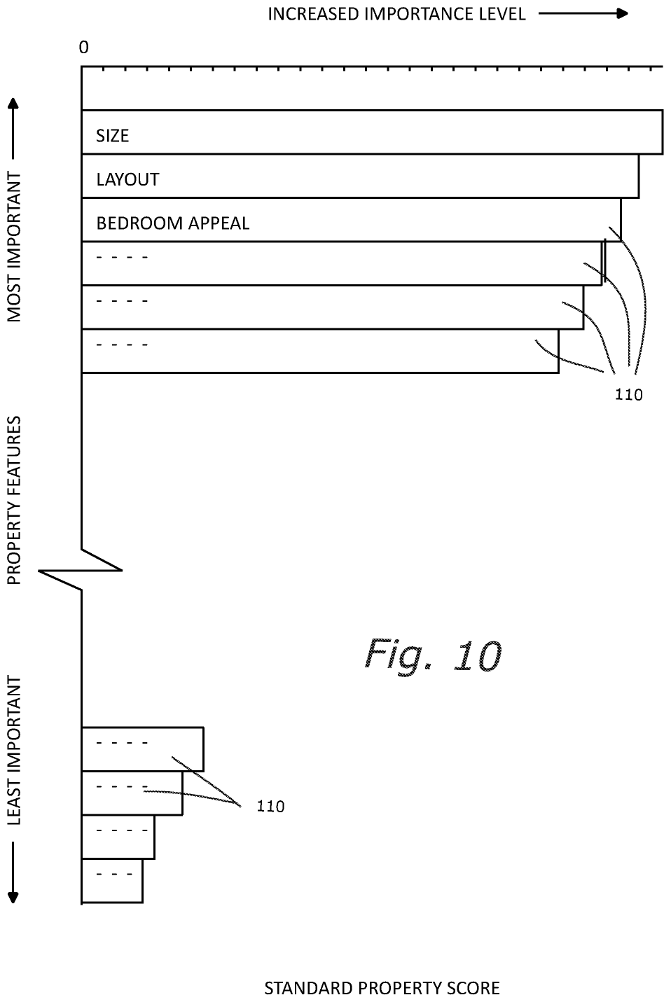

A further enhancement is to provide that chosen features may be grouped in their level of importance; it is particularly envisaged to provide this with the Expert system, but it may be provided with the other systems described herein too. Referring to FIG. 10, the order and relative importance of the different features 110 is chosen by the user as previously described, represented here by the display showing bars for each feature the difference between one feature and the adjacent feature is a uniform amount. The ordering of the feature arrangement is based on the position of each feature with the most important features positioned at the left hand side of the chart. Note that each feature will still be individually scored by the user later on in the process, as is also the case with the Basic and Standard systems.

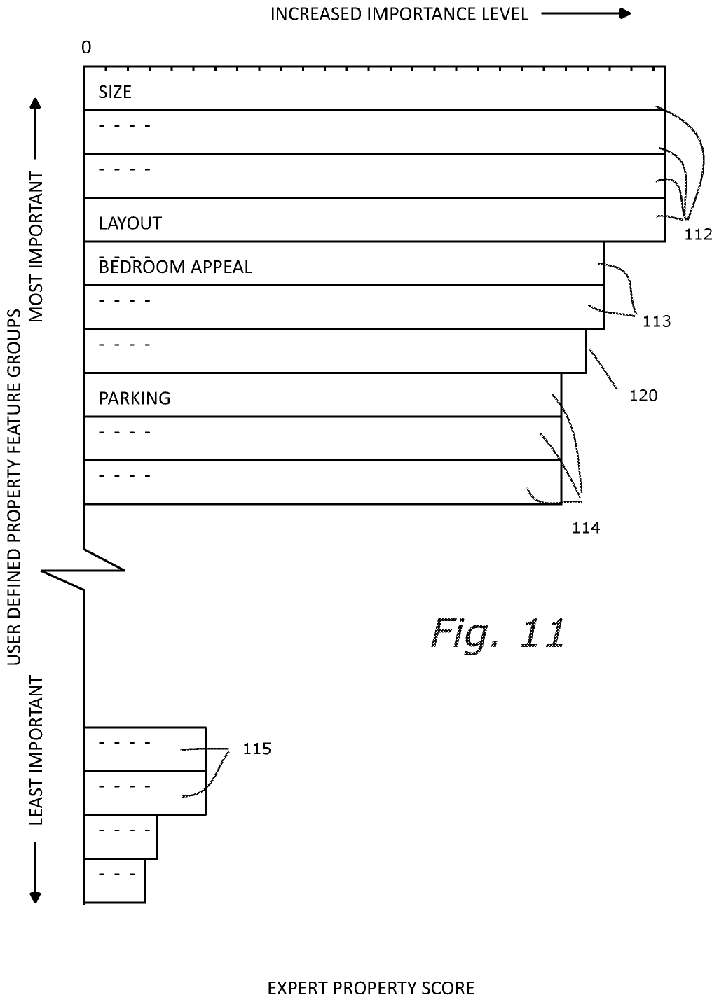

For the Expert system, referring to FIG. 11, certain features that are of equal importance to the user are then selected to be grouped together. A group can be as small as just one feature title or comprise of as many feature titles as the user feels are appropriate. As shown here, the user can decide on the importance level of each feature and now two or more features can be given the same importance. The user is free to group the features together that they feel are of equal importance. A group of features can be as big or as small as the user feels is appropriate. Note that each feature will still be individually scored by the user later on in the process. This will affect the users overall property score in a way that reflects the grouping performed by the user. The user is still required to arrange 16 the features in order of importance as shown and described in relation to FIG. 1.

The algorithm will be adjusted in the background to reflect the feature grouping and the scoring performed by the user.

In this group based system, one algorithm to calculate a score out of 10 may be calculated thus

$${T}_{1} = \frac{1}{n} {\sum }_{1}^{n} ( user feature score from 0 to 10 )$$

$$Final percentage score = \frac{1}{10} {\sum }_{{T}_{1}}^{{T}_{n}} {T}_{n}$$

where n is the sum total length of all the features on the horizontal scale with features marked N/A being discounted, Tn is the total number of feature on the vertical scale.

As shown here, four features 112 are grouped together, three features 113 are grouped together in another group, three features 114 are grouped together in a further group, and two features 115 are grouped together in another group. The user may choose not to group features, or only group some features; as shown in FIG. 11, feature 120 for example is ungrouped.

For example if the user feels that the exterior appeal, layout and internal condition of the property are of equal importance, then the user can group these three items together. Since the user has previously arranged their features into an order of importance, the user can then group adjacent feature titles in their importance feature list.

In order to create a group, the user can use an “add group button” (not here shown) and the pointer on their device and the user will be able to highlight the adjacent features to form as part of a group. If the user makes a mistake or decides that a feature should now not be part of a group, the user can use the “delete group” button to “unhighlight” the group.

Creating groups allows the user to be able to move the group as one single, equally important entity in the next stage. When the user has finished completing their groups, the user can lock their groups. Their feature list will now be arranged into an order of importance feature groups. Again, the number of groups is entirely up to the user's discretion.

On the next screen, the user will see their feature groups arranged in different colours with the most important groups in the uppermost position and lesser important groups lower down. There is also a scale on the top of their screen with points up to 50, which is useful as a reference scale for the user.

The user may then move the groups to the right with regard to this scale. The uppermost group should therefore represent the maximum or a high value on the scale. As the user goes further down the group list, the importance level should decrease as the user feels is appropriate. The lowermost group can have a very low value indicated on the scale.

After completing the group positioning, the user can check and lock their group arrangement and close the program until revisiting the property. It should be noted that a lower positioned feature group cannot have more points than a higher positioned feature group as all of their features were previously arranged into an order of importance. The program will not permit the user to take such an action.

Thus, when grouping is used, the system calculates a percentage score for the user of their subject property taking by giving equal value to the feature grouping performed by the user rather than the number of points allocated to each feature as awarded by the user described in the previous embodiment. Both methods will allow the user to give equal importance to two or more features before individually scoring each feature.

Referring to FIG. 7, after the scoring process, the user can insert the agreed purchase price or the annual rental figure and the property data pack could include 43, 44 an allocation of a monetary amount corresponding to the proportion of the importance of each feature; that is, the total value of the property or its annual rental could be apportioned for each feature using the combination of the number of points allocated and the marks out of ten given by the user. For example, referring to table 1, a property with an asking price of £700,000 could have its cost allocated between the features as shown. This shows the user the particular contribution of each feature, according to their specific grouping (or points allocation in an alternative embodiment) and scoring, as a proportion of the overall cost of the property.

| Feature | Percentage | Proportionate | Cost with | Cost with |
|---|---|---|---|---|
| name | (example) | cost of feature | stamp duty | additional fees |
| 1)Location | 17.2 | £120,400 | £124,700 | £125,302 |
| 2)Size | 15.9 | £111,300 | £115,275 | £115,831 |
| 3)Layout | 12.6 | £88,200 | £91,350 | £91,791 |
| . . . | | | | |
| 25) EPC | 0.8 | £560 | £580 | £582.80 |
| Totals | 100% | £700,000 | £725,000 | £728,500 |

A similar display can be generated for a rental property, allocation with an annual total rental amount to each particular feature with additional column headings for annual energy cost, council tax and other outgoings according their ranking and specific score. Still referring to FIG. 7, the report so generated could be shared with colleagues or clients 45.

A further feature that may be provided with the system, in particular an Expert version of the system, is to provide an ability of the user to add or remove features 30 of the system. For example, the user could be permitted to add up to five, or possibly more features that they consider important criteria, or to remove up to three or more features from the entire scoring process which they feel are irrelevant. For the system which relies on grouping of (similar importance) features as the user feels is appropriate and arranging the groups into a further order of importance.

For example, if a property is being scored and the user wants to score the pool in the garden as a separate feature, he/she can use the “add feature” button to add the extra feature and to name it as “pool”. Also if the same user wants to separate two combined named features and score them separately, the user can add another feature and score it separately whilst also editing the name of a given feature.

The system will be designed to have an in-built algorithm that will adjust its calculation, based on the number of features being input. This ensures a simple percentage score at all times.

The Property score Expert app gives the user total control of their feelings towards buying or renting a property. The user can:
Arrange the features in their desired order.
Add/remove and rename a feature.
Group features together to give them equal importance and move the group into a further order of importance.
Score each feature separately
Obtain a single percentage score which will indicate if the user should buy/rent the subject property.

The differences between the two versions are summarised in FIG. 6.

### Agent Version

For a property agent, that is, for someone providing different property sale or property rental opportunities to a range of clients, the system may be further expanded.

A set of ready made buyer/tenant profiles will be provided, where there are specific categories or titles for different types of prospective buyers or tenants, for each title there will be a pre-arranged list of their suggested features 30 and feature order or arrangement to form a profile for each type of client. A specific title or category could for example include (1) a single person, (2) a small family, (3) a property developer, etc. Each title will have specific features arrangements typically relevant to the client of the specific title, and a specific pre-arranged ordering of the features for that specific client profile.

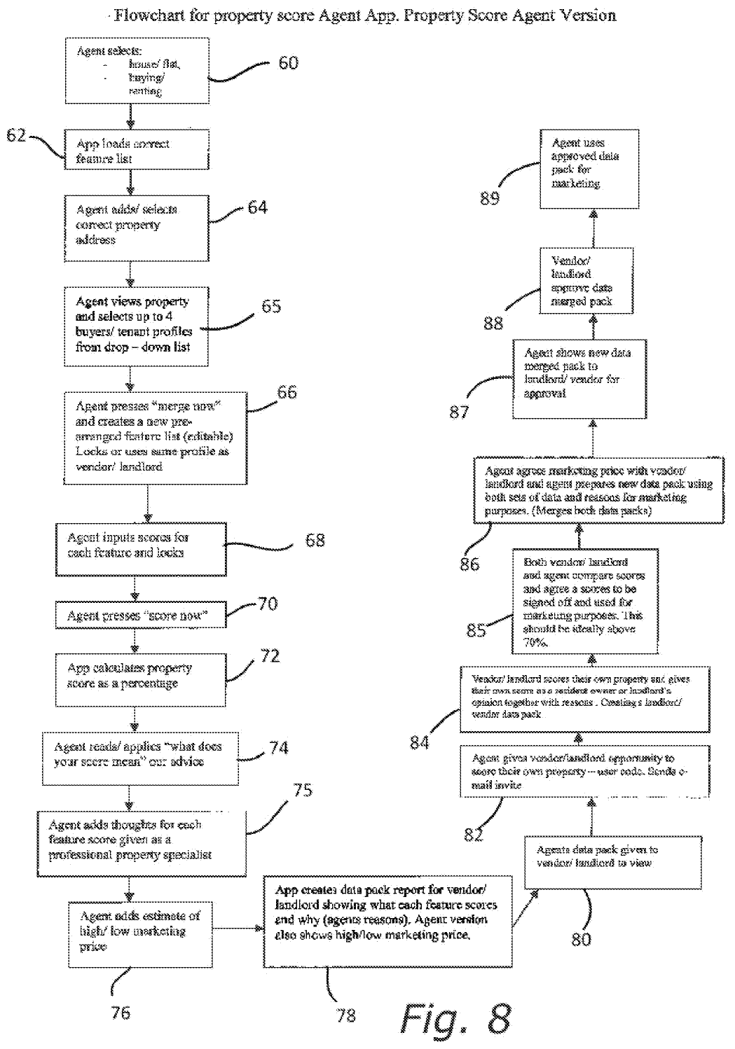

Referring to FIG. 8, the agent can select 65 a number of profile titles, for example up to four profile names, and the system will load the pre-arranged features for these profiles. The system allows the agent to select 65 and merge 66 the individual profiles to create a new list of features that will reflect the suggested feature arrangement for a prospective buyer or tenant for the subject property. These profiles are pre-created from previous data collected from previous buyers and tenant (system users). An agent can merge 2, 3 or 4 different buyer/tenant profiles to create a new buyer/tenant profile that will reflect the arrangement of the individual buyer or tenants' profiles. This works by the following steps.
1. Select the most likely buyer/tenant profile first, then the second most likely then the third and finally the fourth.
2. The system is designed to take the top result/feature from the first profile as position 1.
3. Then the top result from the second profile as position 2
4. Then the top result from the third profile as position 3
5. Then the top result from the fourth profile as position 4.
6. If a feature has already been used then it will take the next available feature in the specific/appropriate profile list.
7. Similarly, if 2 features have already been used, then it will take the next available feature in the appropriate profile list.

As well as different categories of buyers, there will be different categories of tenants; a profile of relevant features and typical ordering of those features for each category of tenant equally applies. The profiles of buyers and tenants can be merged. Tenant profile names include, a single person, a couple, 2 sharers, 3 sharers, 4 sharers, a small family (up to 2 kids), a large family.

The agent would be provided with a dashboard on the property-score website which will be best used on a tablet device, laptop or desktop computer.

In the example in table 2, for a property that the agent is valuing, the agent has selected his/her most likely buyer to be a single person. His/her second most likely buyer to be a couple. His/her third most likely buyer to be a developer and lastly a property investor. A merged profile is created using the 4 selected profiles in the right-most column.

| | | | | Merged |
|---|---|---|---|---|
| Profile 1 | Profile 2 | Profile 3 | Profile 4 | Profile |
| A single | A couple | A developer | An investor | Merged |
| person | | | | 4 profiles |
| Top most | Top most | Top most | Top most | New |
| feature is | feature is | feature is | feature is | drop |
| used as | used for | used for | used for | down |
| position 1 | position 2. | position 3. | position 4. | list will |
| | If the feature | If the feature | If the feature | be |
| | title has | title has | title has | created |
| | already been | already been | already been | |
| | used, then | used, then | used, then | |
| | the next un- | the next un- | the next un- | |
| | used feature | used feature | used feature | |
| | will be used | will be used | will be used | |
| Next unused | etc | | | |
| feature is | | | | |
| used for | | | | |
| position 5. | | | | |
| If the feature | | | | |
| title has | | | | |
| already been | | | | |
| used, then | | | | |
| the next un- | | | | |
| used feature | | | | |
| will be used | | | | |

The new merged list will be ready for the agent to simply go round to a subject property and score each feature. The merged list will be editable for the agent, if required.

Alternatively the agent can look at the Vendor/Landlord's profile and consider the profile of the prospective buyer/tenant to be similar to that of the vendor/vacating tenant at the time when they first purchased/rented the property. In this way, the agent would not need to use the merging process and simply apply the same profile as the vacating tenant/vendor. Having arranged the features into a merged or owner/vacating tenant profile and locked the arrangement, the user can input 68 and score each feature out of 10 as before. (See FIG. 2).

Once each feature has been scored, the agent can now use the system to obtain 72 one percentage score for the property and use this score to emphasize the saleability/rentability of the property to the vendor/landlord. This should help the agent win more instructions.

After generating a data pack report 78, the agent can also invite the vendor/landlord to view 80 and score 82 their own home with guidance in certain parts of the feature list like “personal locality” etc. In practice there may be an element of bias created if a vendor/landlord scores their own home and so an agent will have prior training and access to the data pack to record why they gave a feature a particular score in creating a landlord/vendor data pack. It should be noted that a vendor/landlord will be looking at the feature-lists with a view to their own past and present experience and property knowledge as owners/landlords of the property. They should be invited by the agent to give reasons behind their scores. For example they would know the neighbours, the structure, and when works were done etc. better than the agent would for the subject property. The owner's/landlord's scores and reasoning should then be compared with the agent's scores. The agent looks at the property as a property specialist with property knowledge in the area as well as knowledge of market conditions. And buyer/tenant requirements.

The two scores and reasons should be compared on the property-score agent website to give the best (most appropriate) scores and reasons. Collectively the agent should be trained on the website to prepare one set of scores with joint reasons to be signed off 85 by the vendor/landlord and agent to be used for property marketing.

The overall compared score will reflect the “vendor/landlord and agents' opinion” where the agent can add reasoning to each feature score 75 as well as providing the normal valuation for the subject property 76.

The objective would be to try and reach as high a score as possible. Ideally above 70% to help in the selling or renting of the subject property. This score will be backed by reasoning that the vendor and agent can justify and use to encourage prospective buyer/tenants into making an offer to buy/rent the subject property.

The Agent should follow the following steps:
1. Before a property valuation or market appraisal, select what the buyer/tenant profiles are likely to be (up to 4).
2. Merge the profiles to get a new buyer/tenant profile list. Or use the single profile as the existing owner/landlord.
3. The agent can score the property whilst on a valuation and give the score with a brief description to the vendor/landlord to give them some insight as to how serious the agent is about selling/renting the subject property.
4. The agent can then inform the vendor/landlord that he/she will email a detailed copy of the score to them. (with associated reasoning for each score).
5. The agent version of the property score also has an area to write notes about each feature to record the reasons for their individual feature scores.
6. On returning to the office, the agent adds reasons as to why they gave a feature a particular score and creates a property data pack. (Agent version). The agent then emails the “data pack” to the landlord/vendor.
7. Next the agent invites the vendor/landlord using an invite function on the system/website to score their own property. The vendor/landlord goes round their property and gives marks for each feature. out of 10.
8. The agent can also assist in the scoring of the property with the vendor present and give advice. This is preferable to show the vendor/landlord how serious the agent is about winning the instruction. Alternatively the vendor/landlord can watch a training video to help them score the subject property.
9. The agent should encourage the vendor/landlord to give their own insight and reasons for their scores from the perspective of a person that has owned or lived in the property for a long time. The vendor/landlord then adds comments to each feature that they have scored in step 7 above (step 84 in FIG. 8), and creates a property data pack of their own.
10. The two separate data packs, the agents one and the vendor/landlords one, can be compared and the reasons can be combined on the agent-score website, to create 86 one new “combined property data pack”. This combining process will be carried out by the agent and will often use the higher of the two scores and a combination of the agent and vendor/landlords' reasons.
11. This new combined property data pack will form 89 the basis of a new property score document which could be used in marketing and negotiations by the agent. It can also be used to be compared with the property score data pack of a potential tenant or purchaser. This is provided that the interested party has already obtained their own property score for the subject property from the property score Standard or Expert application(s).
12. Apart from the actual valuation figure or range given to the vendor/landlord, the agent can also advise the vendor/landlord of their ability to use the system to advise potential buyers or tenants about the benefits of the property and how the system will consider numerous features of the subject property instead of an overbearing influence on a single feature or a gut feeling.
13. Agent wins the instruction.
14. After winning the instruction, the agent shows the property to prospective buyers/tenants and any interested party should carry out their own property score from the normal or pro application. Having obtained a single percentage score, the interested party can be shown the agent/vendors/landlords property score and decide whether the interested party should adjust their scores to see if the property is more suitable to them.
15. Agent training should encourage the interested party only on the reasons behind the agent/vendor/landlord scores and not the feature arrangement. This is because the interested party should be free to arrange the features into an arrangement that is best suited to the buyer/tenant without any advice from the agent. Whilst the buyer/tenant profiles used in step 1 above may be close to the actual buyer/tenant feature list, they are still unlikely to be exactly the same.

Further, the agent's dashboard can provide the following functions:
1. Purchase more credits to be used for property valuations
2. View how many credits are available
3. View download invoices
4. Add property valuation addresses.
5. Use a credit for a valuation.
6. Monitor the expiry date of all credits
7. Share a credit with a prospective vendor/landlords and send them an invite.
8. Use the profile merge process to create a new merged profile.
9. Link their mobile device with the website so that all the scores and reasoning are visible.
10. Use the website itself to prepare a new property score for a property.
11. Use the website to edit reasoning and print out/email property data packs
12. Store valuation data as well as an external photo of the property.
13. Store associated valuation comparable material.
14. Create a folder for each valuation with pdf format score data packs that can be emailed/printed.
15. Invite guests including potential vendors and landlords to use the property-score function.
16. View guests scores and comments
17. Combine the two separate data packs to create one new usable property data pack with the best possible scores and the combined reasoning to create one new property score data pack.

### Agent Credits

A credit is a digital token, for example an 18 digit alpha-numeric code that is sold to the agent in bulk and is linked to the agent's email address together with the credit's expiry date of 1 year after the purchase date.

### Invitees

The agent sends the credit code to a third party vendor/landlord who will be invitees. The invitation is sent together with the agent's email address and the subject properties address.

The invitee goes to the property-score website and uses the invitee tab to login and insert their agent's email address, 18 digit code and their own email address.

They can then prepare their own property score for their property. The invitee will be using the system as a vendor or landlord with or without the agent's presence. If the agent is not present, the vendor/landlord must view a short training video of how to use the system before they start the scoring process.

The invitee views the merged feature list as prepared by the agent and goes round the subject property filling in their scores for each feature together with their reasoning. On completion, a data pack will be created by the vendor/landlord that can be shared with the agent and compared with the agent's own data pack. After comparing, the agent presses the ‘score now’ button″ and a new score is created for the subject property.

It is important to get a justified score that is as close to or above 70 percent to help in advising any potential buyer or tenant to buy or rent the subject property.

The flow chart for the Property score agent app is shown on FIG. 8, and further shows the suggested property score marketing that can be used to help sell/rent the subject property.

### Property Score Marketing

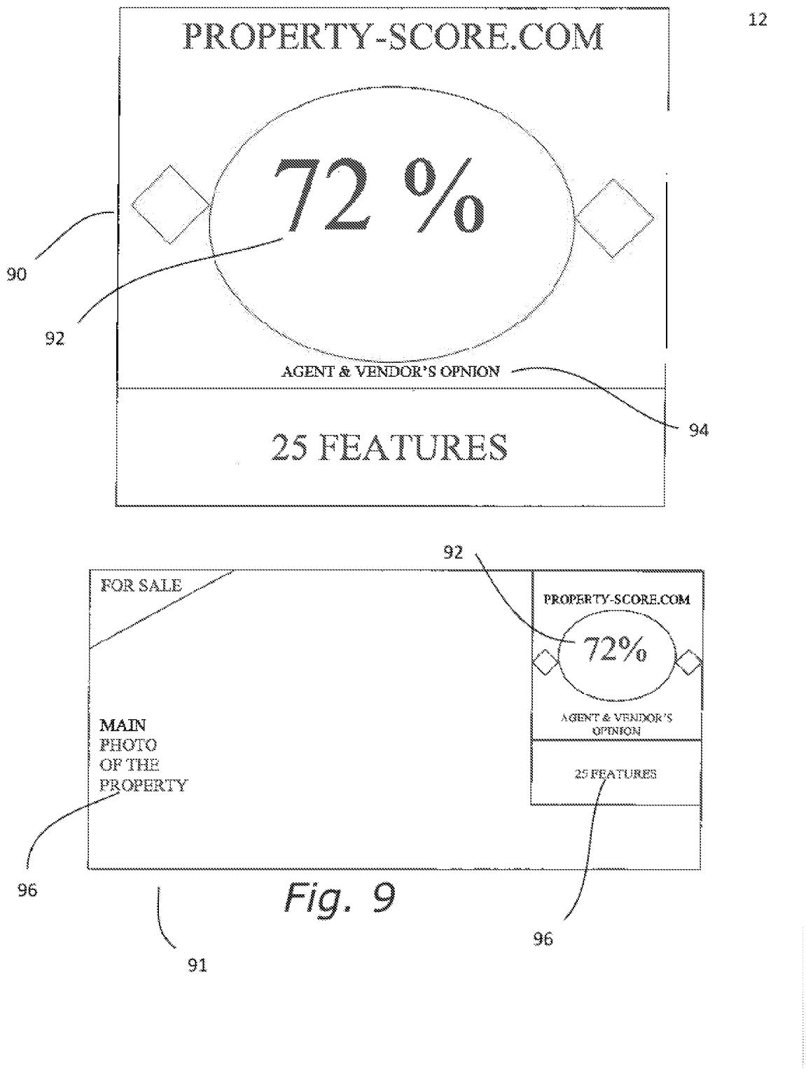

Once the joint vendor/landlord and agent property data packs have been merged to obtain the highest possible, justifiable score, the new, “merged” data pack can be signed off by the vendor/landlord and the agent, to be used for future property marketing, as shown in steps 88, 89 of FIG. 8. This includes being used in property particulars, agent's website and property portal advertising, for example in property score marketing material 90, 91 shown in FIG. 9, where the total score 92 is shown in conjunction with explanatory information 94, and information particular to the property 96.

### Other Uses

This system is essentially an opinion and mathematical based tool that can be adjusted and reconfigured to deal with any complex decision making task. It provides the opportunity for the user to look at the decision making function in such a way that he/she can address all the segments that form part of the problem, arrange them into an order of importance, score each segment and arrive at a simple percentage score that can form the basis of a decision. Alternatively, and where the user feels it is appropriate, the more complex “Expert” version can be used to provide a percentage score, where two or more segments are given equal importance and the grouping function is used.

Outside of the property score system described above, the system can be adjusted and generalised to the evaluation of other assets or characteristics, including the determination of scores on an objective basis for other items that are not necessarily tangible, for example, relationships.

This allows the user to obtain a single percentage figure to represent the importance of their relationship. Where the relationship itself is not limited to that of a husband and wife or boy-friend and girl-friend. It can be any relationship. Since this is a very vast field, the creation of a relationship score app is still undergoing considerable further research.

The five stage process will be more complex than the property-score apps and will involve:
1. Deciding what relationship to score. The user can score, not just a partner, but a friend, relative, business associate, child, employee etc. Similarly the user could be a child and score their mother, father, brother, sister, friend or relative.
2. Selection. Here the user selects appropriate feature (or feature titles, which may of course embodiment further particulars) from various groups or categories to be used for later scoring.
3. Arrangement. Here the user arranges the selected titles into an order of importance as in the property score system described above.
4. Numerical or weighted importance. Additionally or alternatively to the ordering or arrangement of the features, the user can give a value of importance to the selected feature, such as by allocating points from a point allocation system as described above in relation to the sliding indicator icon 55 is provided on slider bar 56 described in relation to FIG. 4, or alternatively group equal importance features together and further arrange the groups into an order of importance as described herein.
5. Scoring. Here the user gives an appropriate score for each feature and the “score-now” button is pressed to calculate a simple percentage score that has been created by the user to represent the importance of their relationship with their chosen person.

The selection process indicated by item 2 above allows the user to select features that are relevant to their preferences in a relationship; further, the system could also provide blank or customisable feature entries for the user to add a feature title of their own choice.

The algorithm will automatically be adjusted to allow for the additional feature titles, either uniformly or if arranged in groups as the user is free to subscribe to their chosen option.

It will be realised that this system could be easily adapted to evaluating other goods, such as making a choice on whether a particular car is suitable for them. Such a system could include the following steps:
1. The user decides to buy a specific car. He/she knows the price and various features about the car.
2. The system asks the user to select a list of features that he/she should like in the car.
3. The system asks the user to arrange the selected features into a list showing the most important ones on the top.
4. Then either use the slider as shown in the property score Expert app or the in-built algorithms to apply the appropriate weighting to each feature, and/or by grouping or the uniform approach as the user feels is appropriate.
5. The individual feature list is then scored by the user and finally a “score it now” button is pressed to determine if the car is the right one for the user based on the user's own input.
6. A simple percentage score is obtained with guidance on what the score means to help the user decide to buy the car or not.
7. The car-score system can be further enhanced to share the user's contact details (if permitted to do so) to specific car manufacturers or dealers. Fees are charged to dealers and manufacturers for sending them interested, pre-scored buyers.

Another use could be for students to help them decide on what course to study at degree level as well as which university to apply to. Again the user's input will be used to create a single percentage score that will determine if the subject course/university is the best (highest scored) one for the user. Another use is deciding on a job opportunity and being able to compare it with an existing job.

The above-described system could easily be varied to evaluating any products or characteristics which would benefit from a systematic and relatively objective scoring and/or comparison system. Resulting in a useful tool for decision making.

In fact some future uses of this system can even be used to create a means of computer led artificial intelligence where the user becomes a data inputter and scorer and the computer determines the input to fulfil an instruction. For example, after a user has input data and scores as previously suggested, the final score, obtained by pressing the ‘score now’ button will give an instruction to the computer to carry out a command. That is to say that if the final score is in the range of 50-60%, then the computer will execute command “A”. If the final score is in the range of 60-70%, then the computer will execute command “B”. Similarly for other scores and other commands. The user may not even have to have any knowledge of what the final score obtained is. Problems of bias and ethics can be overcome by presenting the data inputter with a randomised feature list, where the computer is aware of the correct feature importance arrangement.

### Future Data Uses

Users' choices of feature arrangement can be used in future research, especially to create buyer/tenant profiles for the agent system, if necessary by anonymising the collected data. The collection of such data could be used to—
help with future profile creation for agents
gain an idea of what important features are for buyers (or tenants) within a specific post code
understand what feature is important in a specific area
help with future research and development of the product

In this specification an apparatus/method/product “comprising” certain features is intended to be interpreted as meaning that it includes those features, but that it does not exclude the presence of other features.

It will be realised that some of the steps of the processes described herein could be varied in order; for example, the property location being scored could be entered either before or after the features and their relative importance is set.

Many variations are possible without departing from the scope of the present invention as defined in the appended claims.

1. A system, operating on a computing device, for evaluating a particular subject of a class comprising:
a feature list comprising a plurality of features corresponding to & characteristics or qualities of the subject to be evaluated;
the ordering of the features on the feature list being determined by a user:
the order of features on the feature list being associated with a weighting or ranking position value for that feature,
each feature having a score field in which the user enters a score associated with the feature; and
the system calculating a global score for the subject calculated by multiplying the score associated with the feature with the weighting/ranking associated with the feature, over a selected number of features.

2. A system of claim 1, wherein the weighting/ranking value of each feature may also be assigned by providing the user with a finite number of points to allocate between the features.

3. A system of claim 1, wherein pre-stored features and feature weightings are stored to evaluate further subjects.

4. A system claim 1, wherein the user can add or rename or remove features to the system.

5. A system of claim 1, wherein non-personal user data can be chosen to create a profile.

6. A system of claim 1, wherein non-personal user data from more than one profile may be merged or combined.

7. A system of claim 1, wherein the class is residential property.

8. A system of claim 1, wherein the global score is expressed as a percentage.

9. A system of claim 1, wherein the global score includes a recommendation as to whether to proceed with a decision.

10. A system of claim 1, wherein user can record their reasons for feature arrangements and scores.

11. A system of claim 1, wherein the worth or weighting of a subject or feature to a user is determined.

12. A system of claim 1, wherein the descending order of features corresponds to a descending weighting or ranking of the respective features.

13. A system of claim 12, wherein the weighting of each descending feature decreases by a uniform amount from the feature above.

14. A system of claim 1, wherein mathematics and statistics are brought into the thought processes of an evaluating human brain. In doing so, it creates the basis for a form of artificial intelligence that can be used by modern computer systems to carry out an automated decision based on user input.

15. A system of claim 1, wherein order two or more features may be grouped so that their relative proportions are preserved while still allowing the scoring of one of the grouped features individually.

16. A system of claim 15, wherein order two or more features may be grouped so that the importance, weight or ranking of each grouped feature is equal to the other features within that group prior to scoring.

17. A system of claim 1, wherein features can be chosen to save as a template for future use.

18. A system of claim 17, wherein features from more than one template may be merged or combined.

19. A system of claim 1, wherein a total monetary value for a property is divided according to the proportions of the scored and weighted features to indicate a monetary value of each feature.
